(19) United States
(12) Patent Application Publication
(10) Pub. No.: US 2024/0347843 A1
(43) Pub. Date: Oct. 17, 2024

(54) TRAY ASSEMBLY, POWER BATTERY PACK, AND VEHICLE

(71) Applicant: BYD COMPANY LIMITED, SHENZHEN (CN)

(72) Inventors: Qi WANG, Shenzhen (CN); Jianglong TANG, Shenzhen (CN); Zhipei LU, Shenzhen (CN); Jing TIAN, Shenzhen (CN); Fuxing YANG, Shenzhen (CN)

(21) Appl. No.: 18/755,263

(22) Filed: Jun. 26, 2024

Related U.S. Application Data
(63) Continuation of application No. PCT/CN2023/081434, filed on Mar. 14, 2023.

(30) Foreign Application Priority Data
Mar. 14, 2022 (CN) 202220566246.5

(51) Int. Cl. H01M 50/262; H01M 50/22; H01M 50/242; H01M 50/249; H01M 50/271

(52) U.S. Cl. CPC H01M 50/262; H01M 50/22; H01M 50/242; H01M 50/249; H01M 50/271; H01M 2220/20

(57) ABSTRACT

A tray assembly includes a bottom plate that includes a main body portion and a raised edge portion, an expansion beam, and a first sealing member. The main body portion defines an accommodating cavity configured to accommodate a battery, and the raised edge portion is located on a peripheral of the main body portion and around the main body portion. The expansion beam is disposed on a first side of the raised edge portion and is configured to abut with the battery. The first sealing member includes a first portion disposed between the expansion beam and the raised edge portion.

### CROSS-REFERENCE TO RELATED APPLICATIONS

This application is a continuation application of International Patent Application No. PCT/CN2023/081434, filed on Mar. 14, 2023, which is based on and claims priority to and benefits of Chinese Patent Application No. 202220566246.5, filed on Mar. 14, 2022. The entire content of all of the above-referenced applications is incorporated herein by reference.

### FIELD

The present disclosure relates to the field of vehicle technologies, and in particular, to a tray assembly, a power battery pack, and a vehicle.

### BACKGROUND

In the related art, sealing performance of a power battery pack is poor and hardly meets a design requirement. Especially when an expansion beam and a tray are separately processed members, a sealing arrangement of the power battery pack is complex.

### SUMMARY

The present disclosure resolves at least one of the technical problems existing in the related art. Therefore, the present disclosure provides a tray assembly. The tray assembly has good sealing performance, to meet a sealing requirement of a power battery pack.

The present disclosure further provides a power battery pack including the foregoing tray assembly.

The present disclosure further provides a vehicle including the foregoing power battery pack.

According to embodiments of the present disclosure, in a first aspect, the tray assembly includes: a bottom plate, where the bottom plate includes a main body portion and a raised edge portion, the main body portion defines an accommodating cavity, the accommodating cavity is configured to accommodate a battery, and the raised edge portion is located on a peripheral of the main body portion and around the main body portion; an expansion beam, where the expansion beam is disposed on a first side of the raised edge portion, and the expansion beam is configured to abut with the battery; and a first sealing member, where the first sealing member includes a first portion, and the first portion is disposed between the expansion beam and the raised edge portion.

According to the embodiments of the present disclosure, the tray assembly provides the first sealing member between the expansion beam and the raised edge portion, to seal a gap between the raised edge portion and the expansion beam, so that the sealing performance of the tray assembly is improved. In this way, it is easy to meet a sealing requirement of the power battery pack.

In some embodiments, the tray assembly further includes: a side frame, where the side frame is located on a peripheral of the bottom plate and around the main body portion, the side frame includes multiple side beams connected end to end in sequence, each of the side beams is located on a second side of the raised edge portion and fixed to the raised edge portion, and the raised edge portion includes a first avoiding hole; and a fastener, where the fastener penetrates the first avoiding hole and connects the expansion beam to a corresponding side beam, and the first portion is disposed around the first avoiding hole.

In some embodiments, the first sealing member further includes a second portion, and the second portion is disposed between the fastener and a peripheral wall of the first avoiding hole.

In some embodiments, the side frame further includes a bushing. The bushing penetrates the first avoiding hole and is fixed to the corresponding side beam. The bushing includes a connecting hole. The fastener fits with the connecting hole. The first sealing member further includes a third portion, and the third portion is disposed between the bushing and a peripheral wall of the first avoiding hole.

In some embodiments, the tray assembly further includes: a second sealing member, where the second sealing member includes a fourth portion, and the fourth portion is disposed between each of the side beams and the raised edge portion.

In some embodiments, the fourth portion is disposed around the fastener.

In some embodiments, the side frame further includes the bushing. Each of the side beams includes a second avoiding hole. The bushing is fixed to each of the side beams and at least a portion of the bushing is located on one side of the second avoiding hole facing away from the raised edge portion. The bushing includes a connecting hole. The fastener penetrates the second avoiding hole and fits with the connecting hole.

In some embodiments, one end of the bushing protrudes from the first side of the raised edge portion facing the expansion beam and abuts against the expansion beam.

In some embodiments, the bushing is welded and fixed to a peripheral wall of the second avoiding hole, and a second sealing member covers a welding seam at the second avoiding hole.

In some embodiments, the first sealing member includes the third portion, and the third portion is disposed between the bushing and the peripheral wall of the first avoiding hole; and/or the second sealing member includes a fifth portion, and the fifth portion is disposed between the bushing and the peripheral wall of the first avoiding hole.

In some embodiments, a region of the bushing that abuts against the expansion beam is an annular region, and a radial distance between an outer circumferential edge and an inner circumferential edge of the annular region is greater than or equal to 1 mm.

In some embodiments, the first sealing member or the second sealing member includes a structural adhesive, and a thickness t of the structural adhesive satisfies 0.5 mm≤t≤1 mm.

In some embodiments, the bottom plate includes an insulating material.

In some embodiments, the expansion beam includes a carrying beam and a partition plate. The carrying beam defines a carrying cavity. The partition plate is disposed in the carrying cavity to divide the carrying cavity into a first carrying cavity and a second carrying cavity. The first carrying cavity is located on one side of the second carrying cavity away from the raised edge portion.

In some embodiments, the tray assembly further includes a fastener. The expansion beam further includes: a support member, where the support member is disposed in the second carrying cavity, the support member supports a first cavity wall of the second carrying cavity away from the partition plate and the partition plate, and the fastener penetrates the partition plate and the second carrying cavity and extends out of the second carrying cavity to fix the expansion beam to the corresponding side beam.

In some embodiments, the support member includes multiple support blocks. The multiple support blocks are disposed and spaced from each other along a length direction of the carrying beam. The tray assembly includes multiple fasteners, wherein each of the fasteners penetrates a corresponding support block.

In some embodiments, an area of a cross section of the support member is s1, and an area of a cross section of the second carrying cavity is s2, where 50%≤s1/s2≤60%. The cross section of the support member or the cross section of the second carrying cavity is perpendicular to the length direction of the carrying beam.

In some embodiments, a second cavity wall of the second carrying cavity away from the first carrying cavity includes a mounting through hole. The support member is disposed in the second carrying cavity. A first end of the support member abuts against the partition plate, and a second end of the support member fits with the mounting through hole and is connected to the first cavity wall of the second carrying cavity away from the partition plate.

In some embodiments, the side frame includes the bushing. The bushing is connected to the expansion beam and the fastener, and one end of the bushing adjacent to the expansion beam abuts against the support member.

According to embodiments of the present disclosure, in a second aspect, a power battery pack includes a battery, a sealing cover, and the tray assembly according to the first aspect of the present disclosure. The sealing cover covers an open side of the accommodating cavity and together with the tray assembly defines a mounting space. The battery is disposed in the mounting space.

According to the embodiments of the present disclosure, the power battery pack uses the foregoing tray assembly to meet a sealing requirement of the power battery pack.

In some embodiments, the power battery pack includes multiple batteries and two expansion beams, and the multiple batteries are disposed in a first direction. Each of the batteries extends along a second direction. The two expansion beams are respectively disposed on two sides of the multiple batteries in the first direction. At least one of the two expansion beams extends along the second direction. The second direction is perpendicular to the first direction.

According to embodiments of the present disclosure, in a third aspect, a vehicle includes the power battery pack according to the second aspect of the present disclosure.

According to the embodiments of the present disclosure, the vehicle uses the foregoing power battery pack to ensure safe use of the vehicle.

Additional aspects and advantages of the present disclosure may be given in the following description, some of which may become apparent from the following description or may be learned from practices of the present disclosure.

### BRIEF DESCRIPTION OF THE DRAWINGS

The foregoing and/or additional aspects and advantages of the present disclosure may become apparent and comprehensible in the description of the embodiments made with reference to the following accompanying drawings.

FIG. 1 is a schematic diagram of a tray assembly according to an embodiment of the present disclosure;

FIG. 2 is an enlarged view of a part B circled in FIG. 1;

FIG. 3 is another schematic diagram of the tray assembly shown in FIG. 1;

FIG. 4 is an exploded view of a tray assembly according to an embodiment of the present disclosure;

FIG. 5 is a schematic diagram of a power battery pack according to an embodiment of the present disclosure;

FIG. 6 is another schematic diagram of the power battery pack shown in FIG. 5;

FIG. 7 is a cross-sectional view taken along line C-C in FIG. 6;

FIG. 8 is a schematic diagram of connection of an expansion beam shown in FIG. 7;

FIG. 9 is a schematic diagram of the expansion beam shown in FIG. 8;

FIG. 10 is another schematic diagram of the power battery pack shown in FIG. 5;
and

FIG. 11 is a schematic diagram of a vehicle according to an embodiment of the present disclosure.

### LIST OF REFERENCE NUMERALS

Vehicle 200; power battery pack 100; battery 2; sealing cover 3; tray assembly 1;
tray 11; accommodating cavity 110; bottom plate 111; main body portion 1111;
raised edge portion 1112; first avoiding hole 1112a;
side frame 112; side beam 1121; second avoiding hole 1121a; bushing 1122;
connecting hole 1122a;
expansion beam 12;
carrying beam 1201; carrying cavity 1201a; first carrying cavity 1201b; second carrying cavity 1201c;
mounting through hole 1201d; avoiding through hole 1201e;
partition plate 1202; segmentation portion 1202a; connecting portion 1202b;
support member 1203; support block 1203a;
fastener 13;
first sealing member 141; first portion 141a; third portion 141c; second sealing member 142; fourth portion 142a; and fifth portion 142c.

### DETAILED DESCRIPTION

Embodiments of the present disclosure are described in detail below, and examples of the embodiments are shown in accompanying drawings, where the same or similar elements or the elements having same or similar functions are denoted by the same or similar reference numerals throughout the description. The embodiments described below with reference to the accompanying drawings are examples and used for explaining the present disclosure, and are not as a limitation to the present disclosure.

The disclosure below provides many different embodiments or examples for implementing different structures of the present disclosure. To simplify the disclosure of the present disclosure, the following describes components and settings of some examples. Certainly, the components and settings are merely examples, and are not to limit the present disclosure. In addition, reference numerals and/or letters may be repeated in different examples in the present disclosure. Such repetitions are for simplification and clarity, which do not indicate relationships between the embodiments and/or settings discussed. In addition, the present disclosure provides examples of various processes and materials, but a person of ordinary skill in the art may be aware of the applicability of other processes and/or the use of other materials.

The following describes a tray assembly 1 according to the embodiments of the present disclosure with reference to the accompanying drawings.

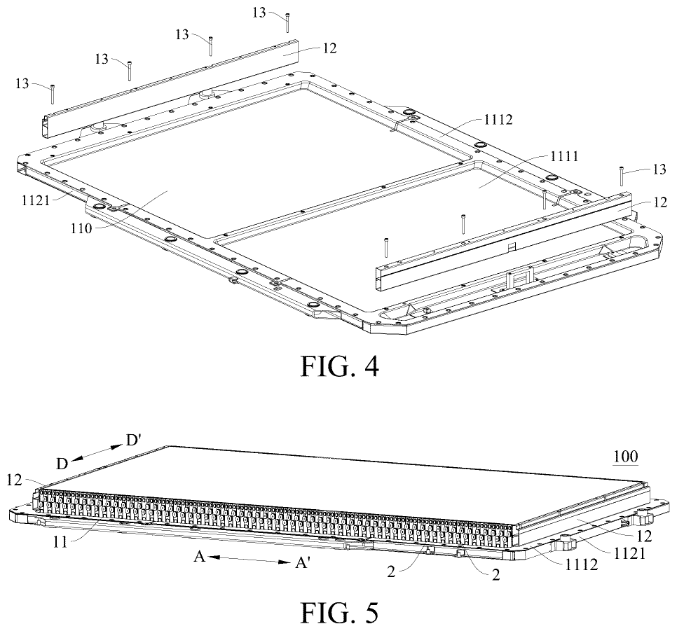

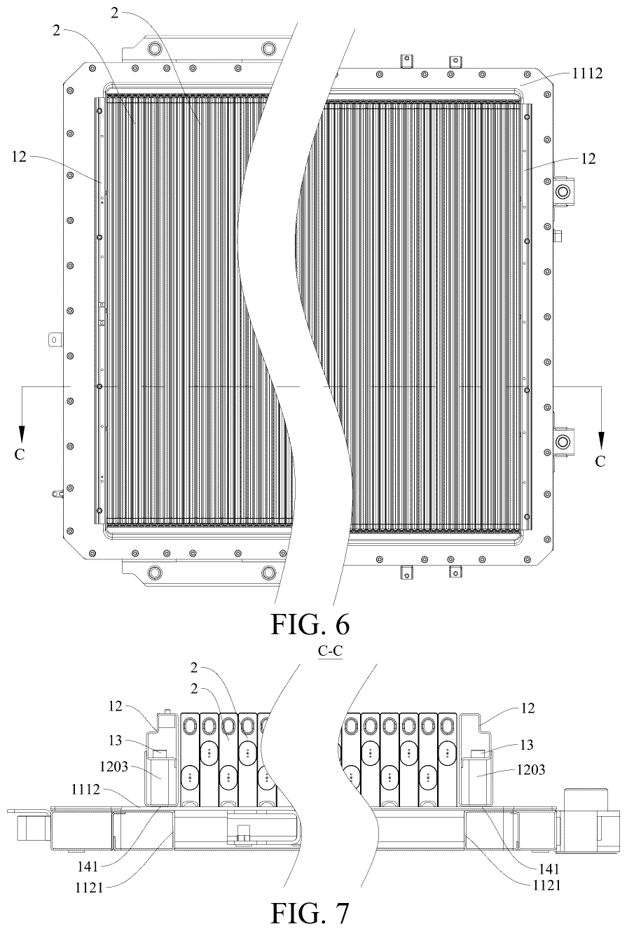

As shown in FIG. 1 and FIG. 4, the tray assembly 1 includes a bottom plate 111. The bottom plate 111 includes a main body portion 1111 and a raised edge portion 1112. The main body portion 1111 defines an accommodating cavity 110. The accommodating cavity 110 is configured to accommodate a battery 2. This facilitates ensuring stable mounting of the battery 2, and in addition, the bottom plate 111 can protect the battery 2. The raised edge portion 1112 is located on a peripheral side of the main body portion 1111, and the raised edge portion 1112 is arranged/disposed around the main body portion 1111. In this way, the raised edge portion 1112 can generally define an annular structure.

It should be noted that, in the description of the present disclosure, “annular” is to be understood in a broad sense, that is, not limited to “circular ring”. For example, it may be “polygonal ring”.

The tray assembly 1 further includes an expansion beam 12. The expansion beam is arranged/disposed on one side (e.g., a first side) of the raised edge portion in a thickness direction. The expansion beam is adapted/configured to abut with the battery. For example, the expansion beam 12 may be in direct contact with the battery 2, or another component may be arranged between the expansion beam 12 and the battery 2 to make the expansion beam 12 indirectly abut against the battery 2. This facilitates the expansion beam 12 to withstand expansion force of the battery 2.

It can be learned that, the expansion beam 12 and the bottom plate 111 are separately processed members.

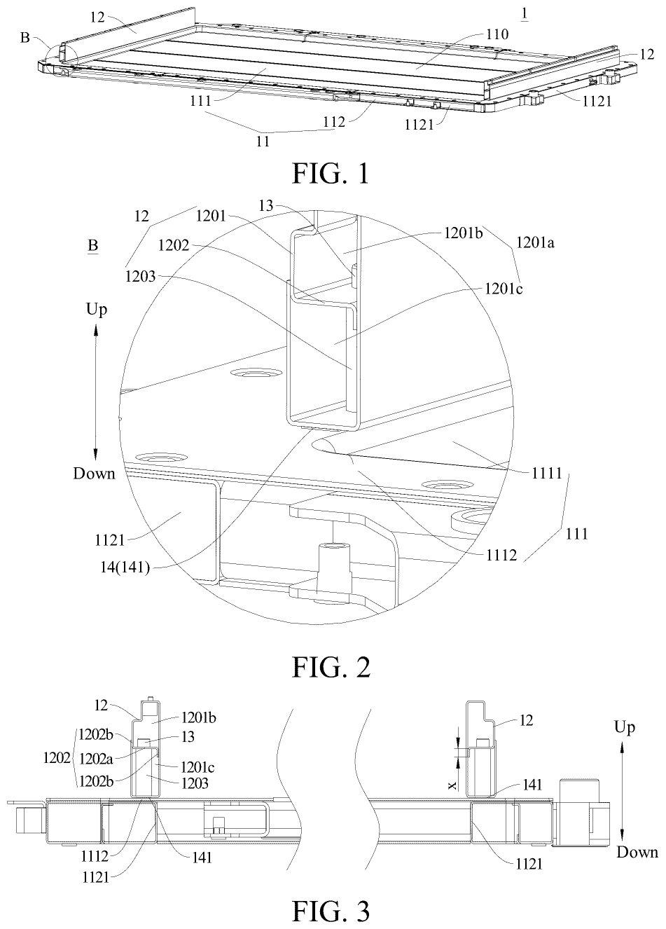

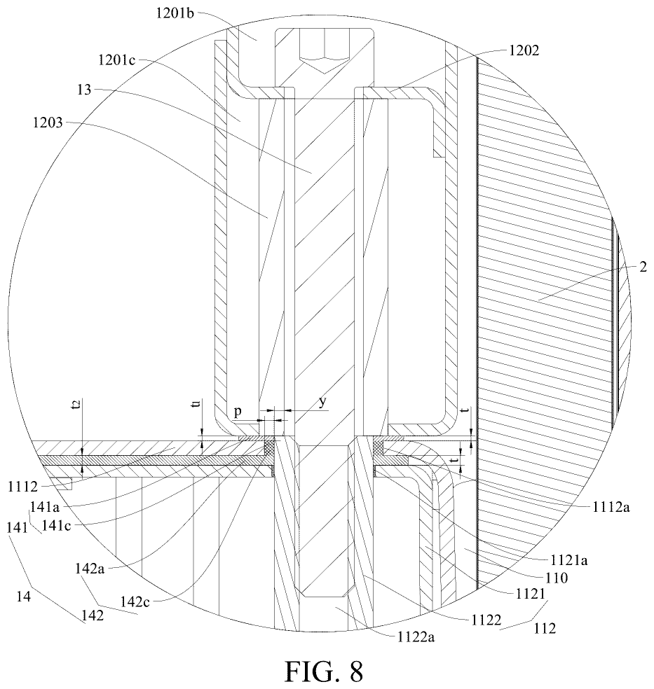

As shown in FIG. 2 and FIG. 8, the tray assembly 1 further includes a first sealing member 141. The first sealing member 141 includes a first portion 141a. The first portion 141a is arranged/disposed between the expansion beam 12 and the raised edge portion 1112. In this way, a portion of the first sealing member 141 is arranged between the expansion beam 12 and the raised edge portion 1112, or the entire first sealing member 141 is arranged between the expansion beam 12 and the raised edge portion 1112, to seal a gap between the expansion beam 12 and the raised edge portion 1112, so that the tray assembly 1 has good sealing performance. Therefore, when the tray assembly 1 is used in a power battery pack 100, it is easy to meet a sealing requirement of the power battery pack 100, to ensure that the power battery pack 100 has good performance such as dustproof and waterproof. In addition, the first sealing member 141 is arranged conveniently, and has a large operating space.

According to the embodiments of the present disclosure, the tray assembly 1 provides the first portion 141a of the first sealing member 141 between the expansion beam 12 and the raised edge portion 1112, to seal the gap between the raised edge portion 1112 and the expansion beam 12, so that the sealing performance of the tray assembly 1 is improved. In this way, it is easy to meet the sealing requirement of the power battery pack 100.

In some embodiments, as shown in FIG. 4, FIG. 7, and FIG. 8, the tray assembly 1 further includes a side frame 112. The side frame 112 is located on a peripheral side of the bottom plate 111, and the side frame 112 is arranged around the main body portion 1111. The side frame 112 includes multiple side beams 1121 connected end to end in sequence, so that the side frame 112 defines an annular structure to facilitate the side frame 112 to stably support the bottom plate 111. The side beam 1121 is located on the other side (e.g., a second side) of the raised edge portion 1112 in the thickness direction, and the side beam 1121 is fixed to the raised edge portion 1112, so that the expansion beam 12 and the side beam 1121 are located on different sides of the thickness of the raised edge portion 1112.

In an embodiment, the side beam 1121 may be a rolled steel member. Certainly, in some embodiments, the side beam 1121 may be an aluminum member.

As shown in FIG. 8, the raised edge portion 1112 includes a first avoiding hole 1112a. The tray assembly 1 further includes a fastener 13. The fastener 13 penetrates the first avoiding hole 1112a, and the fastener 13 fixedly connects the expansion beam 12 to the side beam 1121, so that the first avoiding hole 1112a can avoid the fastener 13, to ensure that the expansion beam 12 is smoothly fixed to a corresponding side beam 1121 through the fastener 13. The first portion 141a is arranged/disposed around the first avoiding hole 1112a, In an embodiment, a portion of the first sealing member 141 between the expansion beam 12 and the raised edge portion 1112 is arranged around the first avoiding hole 1112a.

In some embodiments, the first sealing member 141 further includes a second portion, and the second portion is disposed between the fastener 13 and a peripheral wall of the first avoiding hole 1112a. The first sealing member 141 ensures sealing between the expansion beam 12 and the raised edge portion 1112, and also ensures sealing between the fastener 13 and the raised edge portion 1112, further improving the sealing performance of the tray assembly 1.

In an embodiment, the first sealing member 141 is a structural adhesive. The structural adhesive has good strength, corrosion resistance, and stable performance, to ensure service life of the tray assembly 1. In addition, it is easy to implement bonding and fixing between the expansion beam 12 and the raised edge portion 1112, to improve connection strength between the expansion beam 12 and the raised edge portion 1112. A thickness of the first sealing member 141 is t1, where 0.5 mm≤t1≤1 mm. In this way, difficulty in controlling a processing process caused by an excessively small thickness of the first sealing member 141 can be avoided, and impact on a bonding effect of the structural adhesive caused by an excessively large thickness of the first sealing member 141 can also be avoided. For example, the thickness of the first sealing member 141 may be 0.5 mm, 0.7 mm, 0.8 mm, or 1 mm. Certainly, in some embodiments, the first sealing member 141 may be a sealing ring, for example, a rubber ring.

In an embodiment, when the first sealing member 141 is a structural adhesive, the structural adhesive is in a liquid state during a process of assembling the tray assembly 1. The structural adhesive is arranged/disposed between the expansion beam 12 and the raised edge portion 1112. Through extrusion between the expansion beam 12 and the raised edge portion 1112, the structural adhesive easily overflows between the fastener 13 and the first avoiding hole 1112a. Therefore, when the structural adhesive cures to form the first sealing member 141, it is easy to seal the first portion 141a of the first sealing member 141 between the expansion beam 12 and the raised edge portion 1112, and seal the second portion of the first sealing member 141 between the fastener 13 and the first avoiding hole 1112a.

In some embodiments, as shown in FIG. 8, the side frame 112 further includes a bushing 1122. The bushing 1122 penetrates the first avoiding hole 1112a, and the bushing 1122 is fixed to the side beam 1121. The bushing 1122 forms a connecting hole 1122a. The fastener 13 is fixedly fitted with the connecting hole 1122a. The first sealing member 141 further includes a third portion 141c. The third portion 141c is disposed between the bushing 1122 and a peripheral wall of the first avoiding hole 1112a, to implement sealing between the bushing 1122 and the raised edge portion 1112, further improving the sealing performance of the tray assembly 1. In this case, the bushing 1122 may penetrate the first avoiding hole 1112a.

In some embodiments, as shown in FIG. 8, the tray assembly 1 further includes a second sealing member 142. The second sealing member 142 includes a fourth portion 142a. The fourth portion 142a is arranged/disposed between the side beam 1121 and the raised edge portion 1112. In this way, a portion of the second sealing member 142 is arranged between the side beam 1121 and the raised edge portion 1112, or the entire second sealing member 142 is arranged between the side beam 1121 and the raised edge portion 1112, to seal a gap between the side beam 1121 and the raised edge portion 1112, further improving the sealing performance of the tray assembly 1. This helps ensure that the power battery pack 100 has good performance such as dustproof and waterproof.

In some embodiments, as shown in FIG. 2 to FIG. 4 and FIG. 8, the fourth portion 142a is arranged/disposed around the fastener 13. In an embodiment, a portion of the second sealing member 142 between the side beam 1121 and the raised edge portion 1112 is arranged around the fastener 13, so that one side of the fastener 13 adjacent to the accommodating cavity 110 and one side of the fastener 13 away from the accommodating cavity 110 are respectively arranged with portions of the second sealing member 142. In this way, the portion of the second sealing member 142 located on the side of the fastener 13 adjacent to the accommodating cavity 110 is disposed between the side beam 1121 and the expansion beam 12, and the portion of the second sealing member 142 located on the side of the fastener 13 away from the accommodating cavity 110 is also disposed between the side beam 1121 and the expansion beam 12, facilitating double sealing at the fastener 13, to improve the sealing performance of the tray assembly 1.

In an embodiment, the fastener 13 is a bolt.

In an embodiment, when the second sealing member 142 is a structural adhesive, the structural adhesive is in a liquid state during a process of assembling the tray assembly 1. The structural adhesive is extruded when the fastener 13 fixedly connects the expansion beam 12 to the side beam 1121. After the structural adhesive cures, it is easy to make the second sealing member 142 to be an integral member, to improve setting reliability of the second sealing member 142.

In some embodiments, as shown in FIG. 8, the side frame 112 further includes the bushing 1122. The side beam 1121 forms a second avoiding hole 1121a. The bushing 1122 is fixed to the side beam 1121, and at least a portion of the bushing 1122 is located on one side of the second avoiding hole 1121a facing away from the raised edge portion 1112. The bushing 1122 forms a connecting hole 1122a. The fastener 13 penetrates the second avoiding hole 1121a and penetrates the connecting hole 1122a, and the fastener 13 is fixedly fitted with the connecting hole 1122a, so that the fastener 13 is fixedly connected to the bushing 1122, and the expansion beam 12 is fixed to a corresponding side beam 1121.

In this way, by configuring the bushing 1122 on the side beam 1121 and allowing the fastener 13 to fixedly connect the expansion beam 12 to the bushing 1122, fixed connection between the expansion beam 12 and the side beam 1121 is implemented. Therefore, there is no need to separately process the connecting hole 1122a on the side beam 1121. This helps simplify a structure of the side beam 1121, and facilitates arrangement of the connecting hole 1122a. In addition, at least a portion of the bushing 1122 is located on one side of the second avoiding hole 1121a facing away from the raised edge portion 1112. This helps increase a length of the fastener 13 extending out of the expansion beam 12, to improve connection strength between the side beam 1121 and the expansion beam 12 to some extent.

In some embodiments, as shown in FIG. 8, one end of the bushing 1122 protrudes from one side of the raised edge portion 1112 facing the expansion beam 12, and the one end of the bushing 1122 abuts against the expansion beam 12. In this way, the one end of the bushing 1122 abuts against the expansion beam 12 through the first avoiding hole 1112a and the second avoiding hole 1121a, so that the bushing 1122 tightly abuts against the expansion beam 12 under an action of the fastener 13. This helps further improve the connection strength between the side beam 1121 and the expansion beam 12.

In some embodiments, as shown in FIG. 8, the bushing 1122 and a peripheral wall of the second avoiding hole 1121a are welded and fixed. The second sealing member 142 covers a welding seam at the second avoiding hole 1121a. In this way, the second sealing member 142 ensures sealing between the side beam 1121 and the raised edge portion 1112, and also ensures sealing between the bushing 1122 and the side beam 1121, further improving the sealing performance of the tray assembly 1.

In an embodiment, the second sealing member 142 is a structural adhesive. The structural adhesive has good strength, corrosion resistance, and stable performance, to ensure service life of the tray assembly 1. In addition, it is easy to implement bonding and fixing between the side beam 1121 and the raised edge portion 1112, to improve connection strength between the side beam 1121 and the raised edge portion 1112. A thickness of the second sealing member 142 is t2, where 0.5 mm≤t2≤1 mm. In this way, difficulty in controlling a processing process caused by an excessively small thickness of the second sealing member 142 can be avoided, and impact on a bonding effect of the structural adhesive caused by an excessively large thickness of the second sealing member 142 can also be avoided. For example, the thickness of the second sealing member 142 may be 0.5 mm, 0.7 mm, 0.8 mm, or 1 mm.

In some embodiments, as shown in FIG. 8, the first sealing member 141 includes the third portion 141c, and the third portion 141c is disposed between the bushing 1122 and the peripheral wall of the first avoiding hole 1112a; and/or the second sealing member 142 includes a fifth portion 142c, and the fifth portion 142c is disposed between the bushing 1122 and the peripheral wall of the first avoiding hole 1112a. The schemes may includes: 1) The first sealing member 141 includes the third portion 141c, and the third portion 141c is disposed between the bushing 1122 and the peripheral wall of the first avoiding hole 1112a; 2) The second sealing member 142 includes the fifth portion 142c, and the fifth portion 142c is disposed between the bushing 1122 and the peripheral wall of the first avoiding hole 1112a; 3) The first sealing member 141 includes the third portion 141c, the second sealing member 142 includes the fifth portion 142c, and either of the third portion 141c and the fifth portion 142c is disposed between the bushing 1122 and the peripheral wall of the first avoiding hole 1112a. It can be learned that the first sealing member 141 and/or the second sealing member 142 further ensure/ensures the sealing between the bushing 1122 and the raised edge portion 1112, to further improve/the sealing performance of the tray assembly 1.

In an embodiment, when either of the first sealing member 141 and the second sealing member 142 is disposed between the bushing 1122 and the peripheral wall of the first avoiding hole 1112a, the first sealing member 141 and the second sealing member 142 may form an integral member, to further improve the sealing performance of the tray assembly 1. Certainly, when a portion of the first sealing member 141 or a portion of the second sealing member 142 is disposed between the bushing 1122 and the peripheral wall of the first avoiding hole 1112a, the first sealing member 141 and the second sealing member 142 may also form an integral member.

In an embodiment, a reserved gap p is provided between the bushing 1122 and the peripheral wall of the first avoiding hole 1112a, where 0.5 mm≤p≤1 mm, to ensure that during the process of assembling the tray assembly 1, the first sealing member 141 and/or the second sealing member 142 overflow/overflows between the bushing 1122 and the peripheral wall of the first avoiding hole 1112a, to implement sealing between the bushing 1122 and the peripheral wall of the first avoiding hole 1112a.

In some embodiments, as shown in FIG. 8, a region of the bushing 1122 that abuts against the expansion beam 12 is an annular region. A radial distance between an outer circumferential edge and an inner circumferential edge of the annular region is greater than or equal to 1 mm, to ensure an effective abutment between the bushing 1122 and the expansion beam 12.

It should be noted that, in the description of the present disclosure, “annular” is to be understood in a broad sense, that is, not limited to “circular ring”. For example, it may be “polygonal ring”. The “annular region” may then refer to a circular annular region, a polygonal ring region, or the like. In the example of FIG. 8, the annular region of the bushing 1122 that abuts against the expansion beam 12 is a circular annular region. A radial distance between an outer circumferential edge and an inner circumferential edge of the circular annular region is y, where y is greater than or equal to 1 mm.

In some embodiments, either of the first sealing member 141 and the second sealing member 142 is a structural adhesive. The structural adhesive has good strength, corrosion resistance, and stable performance, to ensure service life of the tray assembly 1. A thickness of the structural adhesive is t, where 0.5 mm≤t≤1 mm. In this way, difficulty in controlling a processing process caused by an excessively small thickness of the structural adhesive can be avoided, and impact on a bonding effect of the structural adhesive caused by an excessively large thickness of the structural adhesive can also be avoided. For example, the thickness t of the structural adhesive may be 0.5 mm, 0.7 mm, 0.8 mm, or 1 mm.

In some embodiments, the bottom plate 111 is an insulating material member. In this case, the bottom plate 111 has good electrical insulation. Even if cooling liquid of the power battery pack 100 leaks or the like, a risk of high-voltage arcing between the bottom plate 111 and the battery 2 can be avoided, ensuring normal use of the power battery pack 100.

In an embodiment, the bottom plate 111 is a composite material member. It is easy to ensure structural strength of the bottom plate 111 while ensuring electrical insulation of the bottom plate 111, so that the bottom plate 111 stably carries the battery 2.

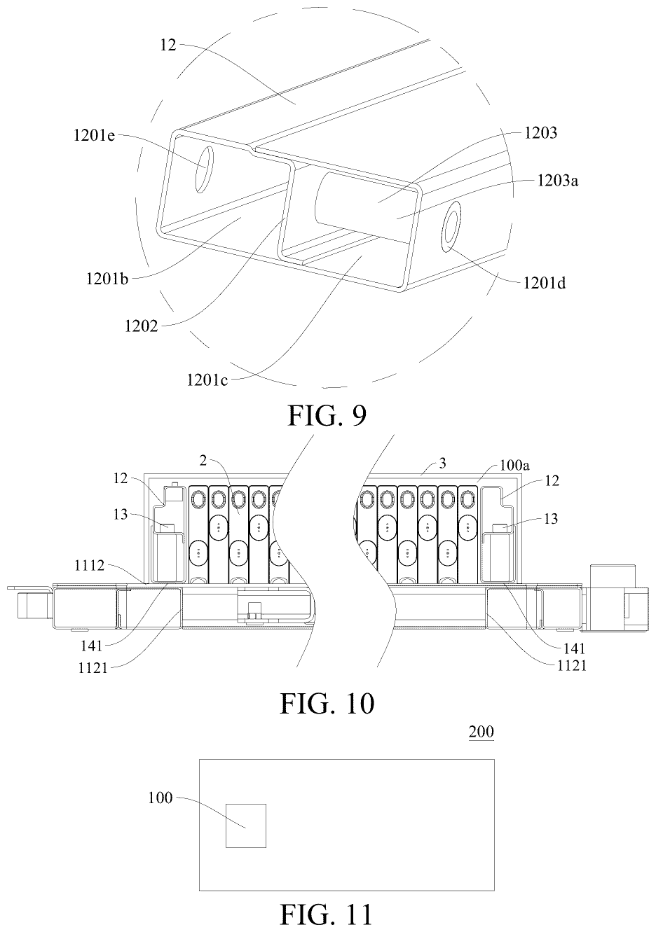

In some embodiments, as shown in FIG. 2, FIG. 3, FIG. 8, and FIG. 9, the expansion beam 12 includes a carrying beam 1201 and a partition plate 1202. The carrying beam 1201 defines a carrying cavity 1201a. The partition plate 1202 is arranged/disposed in the carrying cavity 1201a to divide the carrying cavity 1201a into a first carrying cavity 1201b and a second carrying cavity 1201c. The first carrying cavity 1201b is located on one side of the second carrying cavity 1201c facing away from the raised edge portion 1112. It can be learned that when the expansion beam 12 is in use, the partition plate 1202 can act to transmit expansion force, to ensure a carrying capacity of the expansion beam 12.

For example, in the example of FIG. 8, the first sealing member 141 is arranged at least between the carrying beam 1201 and the raised edge portion 1112.

In some embodiments, as shown in FIG. 3 and FIG. 7, the partition plate 1202 is arranged horizontally. A height of the first carrying cavity 1201b is equal to a height of the second carrying cavity 1201c. For example, in an up-down direction, the partition plate 1202 is located substantially in a middle of the carrying cavity 1201a. When the battery 2 expands, a middle position of the battery 2 deforms the most in the up-down direction. In this case, a position of the partition plate 1202 can better match deformation distribution of the battery 2, to ensure that the expansion beam 12 stably withstands the expansion force of the battery 2.

For example, a surface of the expansion beam 12 facing the battery 2 is subjected to the expansion force of the battery 2. On the surface of the expansion beam 12, the closer to the middle position, the greater the force. By setting the height of the first carrying cavity 1201b equal to the height of the second carrying cavity 1201c, it is easy to ensure that the partition plate 1202 stably transmits the expansion force.

In some embodiments, as shown in FIG. 3 and FIG. 7, in a cross section of the expansion beam 12, the carrying beam 1201 and the partition plate 1202 define an “8”-shaped structure. In this case, a shape of a cross section of the carrying beam 1201 is a square structure, and two side surfaces of width of the carrying beam 1201 may be formed substantially as a plane. At least one of the two side surfaces may be arranged toward the battery 2 to form a carrying surface, then the carrying surface is a plane, so that the force on the expansion beam 12 is uniform. This helps avoid stress concentration of the expansion beam 12 due to uneven force, reduces a risk of bending of the expansion beam 12, and effectively ensures structural safety of the tray assembly 1. The cross section of the expansion beam 12 is perpendicular to a length direction of the expansion beam 12.

It may be understood that, during a process of mounting and using the expansion beam 12, if the expansion beam 12 interferes with another structure such as a cooling pipe, an avoiding portion may be provided on the carrying beam 1201, to ensure smooth mounting of the expansion beam 12 after ensuring structural strength of the carrying beam 1201.

In some embodiments, as shown in FIG. 3 and FIG. 7, the carrying beam 1201 and the partition plate 1202 form an integral bent member, and the bending times is reduced. This simplifies a bending process and reduces processing costs.

For example, in the example of FIG. 9, for a front expansion beam 12 and a middle expansion beam 12, the carrying beam 1201 and the partition plate 1202 need to be bent 7 times in the bending process, which is a simple and convenient process.

In some embodiments, as shown in FIG. 2 and FIG. 3, the partition plate 1202 has a segmentation portion 1202a and a connecting portion 1202b. The segmentation portion 1202a is located between the first carrying cavity 1201b and the second carrying cavity 1201c. At least one of two opposite ends of the segmentation portion 1202a is provided with the connecting portion 1202b. The connecting portion 1202b is superimposed with a cavity wall of the carrying cavity 1201a, and the connecting portion 1202b is fixedly connected to the cavity wall of the carrying cavity 1201a. A length of the connecting portion 1202b in a normal direction of the segmentation portion 1202a is x, where 6 mm≤x≤12 mm. In this way, by properly setting the length of the connecting portion 1202b, a connection area between the connecting portion 1202b and the cavity wall of the carrying cavity 1201a can be ensured, so that connection strength between the connecting portion 1202b and the cavity wall of the carrying cavity 1201a is ensured, to ensure a stable arrangement of the partition plate 1202.

When the two opposite ends of the segmentation portion 1202a are respectively arranged with connecting portions 1202b, lengths of the two connecting portions 1202b in the normal direction of the segmentation portion 1202a may be equal or not equal.

It may be understood that, when the carrying beam 1201 and the partition plate 1202 form the integral bent member, the length of the connecting portion 1202b is in a range of 6 mm to 12 mm, to ensure bending convenience of the partition plate 1202, which helps reduce difficulty of processing. In this case, at the connecting portion 1202b, a steel plate corresponding to the expansion beam 12 has an overlapping portion. In this way, in the present disclosure, the expansion beam 12 has a small amount of material and low costs.

In an embodiment, the connecting portion 1202b and the cavity wall of the carrying cavity 1201a are welded and fixed, to ensure a sufficient welding region between the connecting portion 1202b and the cavity wall of the carrying cavity 1201a. Therefore, welding strength between the connecting portion 1202b and the cavity wall of the carrying cavity 1201a is ensured, improving a structural stability of the carrying cavity 1201a.

In some embodiments, as shown in FIG. 8, the tray assembly 1 further includes the fastener 13. The expansion beam 12 further includes a support member 1203. The support member 1203 is arranged/disposed in the second carrying cavity 1201c, and the support member 1203 supports the partition plate 1202 and one cavity wall of the second carrying cavity 1201c away from the partition plate 1202, so that the support member 1203 can perform a good support function on the second carrying cavity 1201c. This effectively ensures a structural stability of the second carrying cavity 1201c during a process of mounting the expansion beam 12, using the expansion beam 12, or the like, to avoid large deformation of the second carrying cavity 1201c, and ensuring reliable use of the expansion beam 12. The fastener 13 penetrates the partition plate 1202 and the second carrying cavity 1201c, and the fastener 13 extends out of the second carrying cavity 1201c to fix the expansion beam 12 to the side beam 1121. Because the support member 1203 is arranged in the second carrying cavity 1201c, the support member 1203 can carry fastening force of the fastener 13, to avoid large deformation of the partition plate 1202 easily caused by excessive fastening force, effectively ensuring the carrying capacity of the expansion beam 12.

It can be learned that, in the present disclosure, arranging the support member 1203 is helpful to reduce an arrangement requirement of the fastener 13. In an embodiment, when the fastener 13 is arranged, there is no need to consider a situation that the fastening force causes the large deformation of the partition plate 1202. This facilitates arrangement of the fastener 13.

For example, in the example of FIG. 9, one cavity wall of the first carrying cavity 1201b facing away from the second carrying cavity 1201c includes an avoiding through hole 1201e. Taking a plane perpendicular to an axial direction of the avoiding through hole 1201e as a projection surface, an orthographic projection of a hole wall of the avoiding through hole 1201e on the projection surface is located outside an outer contour of an orthographic projection of the fastener 13 on the projection surface, so that the fastener 13 can penetrate the partition plate 1202 and the second carrying cavity 1201c through the avoiding through hole 1201e. The fastener 13 is a bolt. The partition plate 1202 includes a mating through hole. The fastener 13 penetrates the mating through hole, and one end of the fastener 13 abuts against one side of the partition plate 1202 facing away from the second carrying cavity 1201c. The other end of the fastener 13 is located outside the second carrying cavity 1201c, and the other end of the fastener 13 is fixedly connected to the side beam 1121.

In some embodiments, as shown in FIG. 3 and FIG. 8, the fastener 13 penetrates the support member 1203, that is, the support member 1203 includes a through hole. The fastener 13 penetrates the through hole, and the fastener 13 extends out of the through hole to be fixedly connected to the side beam 1121. In this case, an edge portion of the through hole can stably carry the fastening force, so that either of the support member 1203 and the fastener 13 is evenly forced. This helps further avoid the large deformation of the partition plate 1202.

Certainly, the present disclosure is not limited thereto. In some embodiments, the support member 1203 includes multiple support blocks 1203a. The multiple support blocks 1203a are arranged/disposed and spaced away from each other along a second direction. The fastener 13 is arranged between two adjacent support blocks 1203a, so that the two adjacent support blocks 1203a can carry the fastening force of the fastener 13.

In an embodiment, when the through hole is a circular hole, a diameter of the through hole is greater than or equal to an outer diameter of the fastener 13.

In some embodiments, the support member 1203 includes multiple support blocks 1203a. The multiple support blocks 1203a are arranged spaced away along a length direction of the carrying beam 1201. Each fastener 13 penetrates a corresponding support block 1203a. In this case, multiple fasteners 13 are arranged spaced away along the second direction, to ensure mounting and fixing of the entire expansion beam 12 while ensure that the entire partition plate 1202 does not undergo the large deformation.

It may be understood that a quantity of support blocks 1203a may be greater than or equal to a quantity of fasteners 13. In an embodiment, the quantity of support blocks 1203a is n, where 4≤n≤8, but is not limited thereto.

In some embodiments, an area of a cross section of the support member 1203 is s1, and an area of a cross section of the second carrying cavity 1201c is s2, where 50%≤s1/s2≤60%. Either of the cross section of the support member 1203 and the cross section of the second carrying cavity 1201c is perpendicular to the length direction of the carrying beam 1201. In this way, a relative size of the area of the cross section of the support member 1203 and the area of the cross section of the second carrying cavity 1201c is proper. This facilitates a smooth arrangement of the support block 1203a in the second carrying cavity 1201c, and in addition, ensures a good carrying capacity of the support member 1203.

In an embodiment, s1/s2 may be 0.5, 0.52, 0.53, 0.55, 0.58, 0.6, or the like.

In some embodiments, as shown in FIG. 8 and FIG. 9, one cavity wall of the second carrying cavity 1201c away from the first carrying cavity 1201b includes a mounting through hole 1201d, and a support member 1203 is arranged in the second carrying cavity 1201c. One end of the support member 1203 abuts against the partition plate 1202. The other end of the support member 1203 is fitted with the mounting through hole 1201d, and the other end of the support member 1203 is fixedly connected (for example, welded and fixed) to the cavity wall of the second carrying cavity 1201c away from the partition plate 1202, to ensure that the support member 1203 effectively supports the second carrying cavity 1201c. This avoids the large deformation of the second carrying cavity 1201c, and in addition, avoids a misalignment of the support member 1203 relative to the second carrying cavity 1201c, ensuring a stable arrangement of the support member 1203. In this case, the first sealing member 141 may be arranged between the carrying beam 1201 and the raised edge portion 1112, and between the support member 1203 and the raised edge portion 1112.

In an embodiment, taking a plane perpendicular to an axial direction of the mounting through hole 1201d as a projection surface, an orthographic projection of a hole wall of the mounting through hole 1201d on the projection surface is located outside an outer contour of an orthographic projection of the support member 1203 on the projection surface, so that the support member 1203 is configured to be arranged in the second carrying cavity 1201c through the mounting through hole 1201d. That is, the mounting through hole 1201d can allow the support member 1203 to pass through, to facilitate mounting of the support member 1203. Certainly, the configuration of the support member 1203 is not limited thereto. In some embodiments, the support member 1203 may be arranged inside the second carrying cavity 1201c through one end of the second carrying cavity 1201c in the second direction. At this case, two ends of the support member 1203 in a first direction may respectively abut against corresponding cavity walls of the second carrying cavity 1201c, and the support member 1203 can also effectively support the second carrying cavity 1201c.

In some embodiments, as shown in FIG. 8, the side frame 112 includes the bushing 1122. The bushing 1122 is fixedly connected to the expansion beam 12 and the fastener 13 separately, and one end of the bushing 1122 adjacent to the expansion beam 12 abuts against the support member 1203. The bushing 1122 tightly abuts against the support member 1203 under an action of the fastener 13. This helps further improve the connection strength between the side beam 1121 and the expansion beam 12.

In an embodiment, the bushing 1122 and the side beam 1121 are welded and fixed.

In an embodiment, a region of the bushing 1122 that abuts against the support member 1203 is an annular region. A radial distance between an outer circumferential edge and an inner circumferential edge of the annular region is greater than or equal to 1 mm, to ensure an effective abutment between the bushing 1122 and the support member 1203.

In an embodiment, a wall thickness of the bushing 1122 is equal to a wall thickness of the support member 1203.

According to embodiments of a second aspect of the present disclosure, as shown in FIG. 10, a power battery pack 100 includes a battery 2, a sealing cover 3, and the tray assembly 1 according to the embodiments of the first aspect of the present disclosure. The sealing cover 3 covers an open side of the accommodating cavity 110, and the sealing cover 3 together with the tray assembly 1 defines a mounting space 100a. The battery 2 is provided in the mounting space 100a.

According to the embodiments of the present disclosure, the power battery pack 100 uses the foregoing tray assembly 1 to meet a sealing requirement of the power battery pack 100.

In some embodiments, as shown in FIG. 1, FIG. 3, FIG. 5, and FIG. 7, multiple batteries 2 exist, and the multiple batteries 2 are arranged in a first direction (for example, a direction AA′ in FIG. 5). Each of the batteries 2 extends along a second direction (for example, a direction DD′ in FIG. 5), where the second direction is perpendicular to the first direction. A quantity of expansion beams 12 may be two, and the two expansion beams 12 are respectively arranged on two sides of the multiple batteries 2 in the first direction. In an embodiment, one expansion beam 12 is arranged on one side of the multiple batteries 2 in the first direction, and the other expansion beam 12 is arranged on the other side of the multiple batteries 2 in the first direction. A direction of expansion force of the battery 2 is substantially parallel to the first direction. Either of the expansion beams 12 extends along the second direction, so that either of the expansion beams 12 withstands the expansion force of the entire battery 2.

In this way, by configuring the expansion beams 12 respectively on two sides in an arrangement direction of the multiple batteries 2, a small quantity of expansion beams 12 is used to withstand the expansion force of the battery 2, ensuring safe use of the power battery pack 100.

According to embodiments of a third aspect of the present disclosure, as shown in FIG. 11, a vehicle 200 includes the power battery pack 100 according to the embodiments of the second aspect of the present disclosure.

According to the embodiments of the present disclosure, the vehicle 200 uses the foregoing power battery pack 100, to ensure safe use of the vehicle.

Other configurations and operations of the vehicle 200 according to the embodiments of the present disclosure are known to a person of ordinary skill in the art and will not be described in detail herein.

In the description of the present disclosure, it should be understood that orientation or position relationships indicated by the terms such as “center”, “longitudinal”, “transverse”, “length”, “width”, “thickness”, “on”, “below”, “front”, “back”, “left”, “right”, “vertical”, “horizontal”, “top”, “bottom”, “inside”, “outside”, “clockwise”, “anticlockwise”, “axial direction”, “radial direction”, and “circumferential direction” are based on orientation or position relationships shown in the accompanying drawings, and are used only for ease and brevity of illustration and description, rather than indicating or implying that the mentioned apparatus or component needs to have a particular orientation or needs to be constructed and operated in a particular orientation. Therefore, such terms should not be construed as limiting of the present disclosure. In addition, a feature defined to be “first” or “second” may explicitly or implicitly include one or more features. In the description of the present disclosure, unless otherwise stated, “a plurality of” means two or more than two.

In the description of the present disclosure, it should be noted that, unless otherwise explicitly specified or defined, the terms such as “mount”, “connect”, and “connection” should be understood in a broad sense. For example, the connection may be a fixed connection, a detachable connection, or an integral connection; the connection may be a mechanical connection or an electrical connection; or the connection may be a direct connection, an indirect connection through an intermediate medium, or internal communication between two components. A person of ordinary skill in the art may understand meanings of the foregoing terms in the present disclosure according to situations.

In the descriptions of this specification, descriptions of a reference term such as “an embodiment”, “some embodiments”, “an exemplary embodiment”, “an example”, “a specific example”, or “some examples” means that a feature, structure, material, or characteristic that is described with reference to the embodiment or the example is included in at least one embodiment or example of the present disclosure. In this specification, schematic descriptions of the foregoing terms do not necessarily refer to the same embodiment or example. In addition, the feature, the structure, the material, or the characteristic that is described may be combined in a proper manner in any one or more of the embodiments or examples.

Although the embodiments of the present disclosure have been shown and described, a person of ordinary skill in the art may understand that various changes, modifications, replacements, and variations may be made to the embodiments without departing from the principles and spirit of the present disclosure, and the scope of the present disclosure is as defined by the appended claims and their equivalents.

What is claimed is:

1. A tray assembly, comprising:
a bottom plate comprising a main body portion and a raised edge portion, the main body portion defining an accommodating cavity configured to accommodate a battery, and the raised edge portion located on a peripheral of the main body portion and around the main body portion;
an expansion beam disposed on a first side of the raised edge portion and configured to abut with the battery; and
a first sealing member comprising a first portion disposed between the expansion beam and the raised edge portion.

2. The tray assembly according to claim 1, further comprising:
a side frame located on a peripheral of the bottom plate and around the main body portion, the side frame comprising a plurality of side beams, each of the side beams being located on a second side of the raised edge portion and fixed to the raised edge portion, and the raised edge portion comprising a first avoiding hole; and
a fastener penetrating the first avoiding hole and connecting the expansion beam to a corresponding side beam, and the first portion of the first sealing member being disposed around the first avoiding hole.

3. The tray assembly according to claim 2, wherein the first sealing member further comprises a second portion, and the second portion is disposed between the fastener and a peripheral wall of the first avoiding hole.

4. The tray assembly according to claim 2, wherein:
the side frame further comprises a bushing penetrating the first avoiding hole and fixed to the corresponding side beam, the bushing comprising a connecting hole, the fastener fits with the connecting hole; and
the first sealing member further comprises a third portion, and the third portion is disposed between the bushing and a peripheral wall of the first avoiding hole.

5. The tray assembly according to claim 2, further comprising:
a second sealing member comprising a fourth portion, and the fourth portion being disposed between each of the side beams and the raised edge portion.

6. The tray assembly according to claim 5, wherein the fourth portion is disposed around the fastener.

7. The tray assembly according to claim 2, wherein the side frame further comprises a bushing, each of the side beams comprises a second avoiding hole, the bushing is fixed to each of the side beams and at least a portion of the bushing is located on one side of the second avoiding hole facing away from the raised edge portion, the bushing comprises a connecting hole, and the fastener penetrates the second avoiding hole and fits with the connecting hole.

8. The tray assembly according to claim 4, wherein one end of the bushing protrudes from the first side of the raised edge portion facing the expansion beam and abuts against the expansion beam.

9. The tray assembly according to claim 7, wherein the bushing is welded and fixed to a peripheral wall of the second avoiding hole, and a second sealing member covers a welding seam at the second avoiding hole.

10. The tray assembly according to claim 9, wherein:
the first sealing member comprises a third portion disposed between the bushing and a peripheral wall of the first avoiding hole; and/or
the second sealing member comprises a fifth portion disposed between the bushing and the peripheral wall of the first avoiding hole.

11. The tray assembly according to claim 4, wherein a region of the bushing that abuts against the expansion beam is an annular region, and a radial distance between an outer circumferential edge and an inner circumferential edge of the annular region is greater than or equal to 1 mm.

12. The tray assembly according to claim 5, wherein the first sealing member or the second sealing member comprises a structural adhesive, and a thickness t of the structural adhesive satisfies 0.5 mm≤t≤1 mm.

13. The tray assembly according to claim 1, wherein the bottom plate comprises an insulating material.

14. The tray assembly according to claim 1, wherein the expansion beam comprises a carrying beam and a partition plate, the carrying beam defines a carrying cavity, the partition plate is disposed in the carrying cavity to divide the carrying cavity into a first carrying cavity and a second carrying cavity, and the first carrying cavity is located on one side of the second carrying cavity away from the raised edge portion.

15. The tray assembly according to claim 14, further comprising a fastener, and the expansion beam further comprising:
a support member disposed in the second carrying cavity and supporting a first cavity wall of the second carrying cavity away from the partition plate and the partition plate, and the fastener penetrating the partition plate and the second carrying cavity and extending out of the second carrying cavity to fix the expansion beam to a corresponding side beam.

16. The tray assembly according to claim 15, wherein the support member comprises a plurality of support blocks disposed and spaced from each other along a length direction of the carrying beam, and the tray assembly comprises a plurality of fasteners, wherein each of the fasteners penetrating a corresponding support block.

17. The tray assembly according to claim 15, wherein an area of a cross section of the support member is s1, an area of a cross section of the second carrying cavity is s2, where 50%≤s1/s2≤60%, and the cross section of the support member or the cross section of the second carrying cavity is perpendicular to a length direction of the carrying beam.

18. The tray assembly according to claim 15, wherein a second cavity wall of the second carrying cavity away from the first carrying cavity comprises a mounting through hole, the support member is disposed in the second carrying cavity, a first end of the support member abuts against the partition plate, and a second end of the support member fits with the mounting through hole and is connected to the first cavity wall of the second carrying cavity away from the partition plate.

19. The tray assembly according to claim 2, wherein the side frame comprises a bushing connected to the expansion beam and the fastener, and one end of the bushing adjacent to the expansion beam abuts against a support member.

20. A power battery pack, comprising a battery, a sealing cover, and a tray assembly,
wherein the tray assembly comprises:
a bottom plate comprising a main body portion and a raised edge portion, the main body portion defining an accommodating cavity configured to accommodate a battery, and the raised edge portion located on a peripheral of the main body portion and around the main body portion;
an expansion beam disposed on a first side of the raised edge portion and configured to abut with the battery; and
a first sealing member comprising a first portion disposed between the expansion beam and the raised edge portion; and
wherein the sealing cover covers an open side of the accommodating cavity and together with the tray assembly defines a mounting space, and the battery is disposed in the mounting space.

21. The power battery pack according to claim 20, comprising a plurality of batteries including the battery, and two expansion beams including the expansion beam,
wherein the batteries are disposed in a first direction, each of the batteries extends along a second direction, the two expansion beams are respectively disposed on two sides of the batteries in the first direction, at least one of the two expansion beams extends along the second direction, and the second direction is perpendicular to the first direction.

22. A vehicle, comprising a power battery pack, wherein the power battery pack comprises a battery, a sealing cover, and a tray assembly,
the tray assembly comprising:
a bottom plate comprising a main body portion and a raised edge portion, the main body portion defining an accommodating cavity configured to accommodate a battery, and the raised edge portion located on a peripheral of the main body portion and around the main body portion;
an expansion beam disposed on a first side of the raised edge portion and configured to abut with the battery; and
a first sealing member comprising a first portion disposed between the expansion beam and the raised edge portion; and
the sealing cover covering an open side of the accommodating cavity and together with the tray assembly defining a mounting space, and the battery disposed in the mounting space.
